(19) United States
(12) Patent Application Publication
(10) Pub. No.: US 2017/0099981 A1
(43) Pub. Date: Apr. 13, 2017

(54) CALLISTO INTEGRATED TABLET COMPUTER IN HOT AND COLD DISPENSING MACHINE

(71) Applicants: Michel Abou Haidar, Corona, CA (US); Eddie E. Feghali, Corona, CA (US)

(72) Inventors: Michel Abou Haidar, Corona, CA (US); Eddie E. Feghali, Corona, CA (US)

(21) Appl. No.: 15/279,189

(22) Filed: Sep. 28, 2016

Related U.S. Application Data
(60) Provisional application No. 62/238,909, filed on Oct. 8, 2015.

(51) Int. Cl. A47J 31/44; B67D 1/16; B67D 1/00; G06Q 20/32; G06Q 30/02; G06Q 50/00; G06K 7/14; B67D 1/08; G07F 13/06

(52) U.S. Cl. CPC A47J 31/44; B67D 1/0877; B67D 1/0888; B67D 1/16; B67D 1/0857; B67D 1/0895; B67D 1/0057; A47J 31/4492; G07F 13/065; G06Q 30/0241; G06Q 50/01; G06K 7/1417; G06Q 20/3278; G06Q 10/02

(57) ABSTRACT

Improvements a hot and cold dispensing machine is disclosed. The machine includes creating a family of smart coffee dispensing machine that is connected 24/7 to the cloud. The machines are controllable also by mobile app that use QR code via built in cam or an external reader and/or NFC technology to transfer data and establish communication and execute payments. The android based computer will be used to run the machine as well as to offer all the facilities of a computer or a fully functional tablet like but not limited to: executing commands and dispensing recipes, creating, deleting and editing profiles, change the system settings, connection to the internet, access to social media networks, playing publicity, registering audio/video messages, reading boarding pass codes used in airlines companies for identifying the user and communicating with Smart App via QR Code and/or NFC.

### CROSS REFERENCE TO RELATED APPLICATIONS

This application claims the benefit of Provisional Application Ser. No. 62/238,909 filed Oct. 8, 2016 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

This invention relates to improvements in a hot and cold beverage dispenser. More particularly, the present hot and cold beverage dispenser integrates a personal computing device with a tablet or android computing platform on any coffee machine (Home, commercial or vending) as well as any dispensing machine for hot and cold beverages.

Description of Related Art Including Information Disclosed Under 37 CFR 1.97 and 1.98.

Each person has a different taste, when it comes to beverages and/or food and each person would like to personalize his or her recipes. Studies have shown that no two tastes are the same. It is time to present to the customer the possibility to customize his beverage, moreover to save them for further use at his convenience and the ability to change/modify when desired.

Creating an intuitive user interface for a hot and cold beverage dispenser such as a coffee machine is not an easy task especially when the machine should function as a normal computer with of the expected computing capabilities. Capacitive Touch screens are considered the standard for simple user touch interface and most users expect the same simple touch screen user interface in nearly all aspects of machines they use and interface with.

Today a large percentage of machines are cloud connected and accessible to the user/operator with unlimited access to all machine settings and functionalities as well as for sales reports and all type of statistics related to sales, users, stock management, etc. . . . . With these cloud connected devices, years of test and debugging were spent to deliver the user a home appliance or a commercial appliance of the 3rd millennium standard, ensuring his convenience and widening his choices when choosing his beverages.

The complex database structure that keeps track of every customer's profile, and for every profile its picture, products and recipes for each product, the interactivity using a Web cam, microphone and live video chatting, makes the integration of Android in a Coffee machine or any Hot or Cold dispensing beverage machine is not found in hot and cold beverage dispensers.

A number of patents and or publications have been made to address these issues. Exemplary examples of patents and or publication that try to address this/these problem(s) are identified and discussed below.

U.S. Published application 20120164422 was published on Jun. 27, 2013 for Arren J. McCormick discloses a Coffee Maker Supporting Single Serve & Carafe Operations. There are a number of coffee makers that produce just a single cup of coffee that is made from a single serving concentrated liquid coffee concentrate. This publication creates a bridge between a coffee machine that prepares a single cup and a full pot of coffee. While this publication discloses a machine that can produce one or several cups of coffee, it does not have a user interface that remembers the user preference for the coffee.

U.S. Published application 2012/0037008 was published on Feb. 16, 2012 to Nelson Antonio Rodriguez discloses a Programmable Multiple Ingredient Dispensing Coffee Maker with Customizable Settings for Multiple Individual Preferences. This application discloses a coffee maker that can dispense multiple ingredients into the coffee that is being prepared, but a user must program the coffee maker each time they brew a separate cup.

U.S. Published application 2004/0118294 was published on Jun. 24, 2004 for Wade L. Grassedonio discloses a Semi-automated Coffee Maker. The coffee make uses a bank of separate coffee chambers that index to fill a coffee pot multiple times. The automated portion of the coffee maker still required a user to pre-install multiple coffee packets prior to use of the coffee machine.

What is needed is a hot and cold beverage dispenser that covers the use of any liquid cartridge, in any form in order to dispense Flavors, Syrup, Liquid sugar of all kinds, and tea essence in the coffee dispenser. A tablet computer will be used to run the machine as well as to offer all the facilities of a computer or a tablet. The proposed hot and cold beverage dispenser provides a solution to this problem.

### BRIEF SUMMARY OF THE INVENTION

It is an object of the integrated tablet computer in a hot and cold dispensing machine to integrate an android platform computing device onto a coffee machine (Home, commercial or Vending) as well as any dispensing machine for hot and cold beverages. Also offering internet connectivity and transforming the dispensing machine into a “Smart Multifunctional Dispensing” machine is an objective.

It is another object of the integrated tablet computer in a hot and cold dispensing machine for the android based computer to run the machine as well as to offer all the facilities of a computer or a fully functional tablet like but not limited to executing commands and dispensing recipes, creating, deleting and editing profiles, change the system settings, connection to the internet, access to social media networks, playing publicity (whether pushed adds or online, makes the dispensing/coffee machine more attractive and can transmit useful information to the user while waiting for brewing/dispensing his drink), registering audio/video messages, reading QR codes via built in cam or an external reader, reading boarding pass codes used in airlines companies for identifying the user and communicating with Smart App via QR Code and/or Blue Tooth and/or NFC device or by a Boarding pass code in an airport, will help retrieving the user's profile from remote server immediately so that he can have his preferred drink.

Accordingly, it is a main target of the present Utility Invention to provide an improved interface for the dispensing machine user to customize his or her drinks and saving them for future use.

It is still another object of the integrated tablet in a hot and cold dispensing machine for the cartridges to be are operated by special peristaltic pumps that prevent cross contamination.

Various objects, features, aspects, and advantages of the present invention will become more apparent from the following detailed description of preferred embodiments of the invention, along with the accompanying drawings in which like numerals represent like components.

A machine that can operate the concept of a dispensed coffee called “Hug in a Mug” in the Callisto System, where the end user can send via his mobile app a “Paid Voucher” that will be printed on a special Ticket operated by NGO in third world countries or in Locations where poor people can get benefit of it. The beneficiary of the Ticket goes to the Machine, scans his Ticket for verification, the machine will dispense the drink and takes a snapshot or video of the beneficiary and sends it back to the user by thanking him on behalf of the NGO and showing a picture/video of the beneficiary.

### BRIEF DESCRIPTION OF THE SEVERAL VIEWS OF THE DRAWING(S)

FIG. 1 shows a block diagram of the Uber Café Callisto product family.

FIG. 2 shows a block diagram of the three main servers in the Uber Café Callisto product family.

FIG. 3 shows the three main servers in the Uber Café Callisto product family.

FIG. 4 shows a second block diagram of the Uber Café Callisto product family.

### DETAILED DESCRIPTION OF THE INVENTION

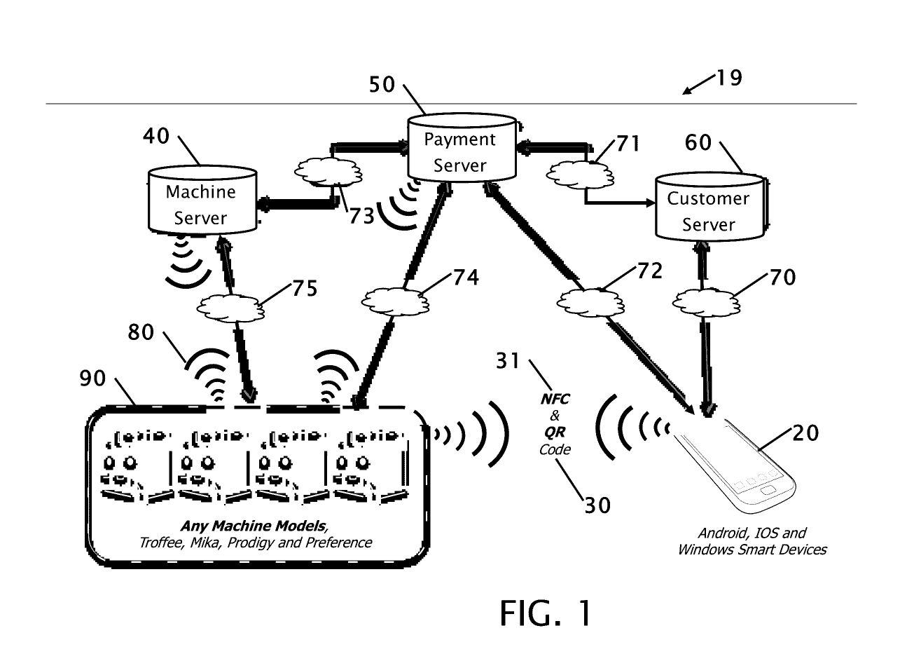

FIG. 1 shows a block diagram of the Uber Café Callisto product family 19. The present hot and cold dispensing machine is about integrating the android platform on any coffee machine (Home, commercial or Vending) as well as any dispensing machine for hot and cold beverages. An android based computer, tablet, or other IOS and windows smart device 20 will be used to run the machine as well as to offer all the facilities of a computer or a fully functional tablet like but not limited to executing commands and dispensing recipes, creating, deleting and editing profiles, change the system settings, connection to the internet, access to social media networks, playing publicity (whether pushed adds or online, makes the dispensing/coffee machine more attractive and can transmit useful information to the user while waiting for brewing/dispensing his drink), registering audio/video messages, reading QR codes via built in cam or an external reader, reading boarding pass codes used in airlines companies for identifying the user and communicating with Smart App via QR Code 30 and/or Blue Tooth and/or NFC 31 device or by a Boarding pass code in an airport, will help retrieving the user's profile from remote server immediately so that he can have his preferred drink. Accordingly, it is a main target of the present Utility Invention to provide an improved interface for the dispensing machine user to customize his or her drinks and saving them for future use. The system can make suggests of other combinations based up on combinations or mixtures from other users.

The system includes a machine server 40 connected through a cloud interface 73 to a payment server, through a cloud interface to a customer server 60. The smart device 20 communicated through the cloud 72 to the payment server 50 and though the cloud 70 to a customer server 60.

Any machine models 90 of hot or cold dispensing machines, such as Troffee, Mika, Prodigy and Preferences communicates through the cloud 75 or through a wireless connection 80 to the machine server to obtain the preferences of a user and also to identify when servicing of a machine is required. The machines 40 can also communicate through the cloud 74 or wirelessly to the payment server 50.

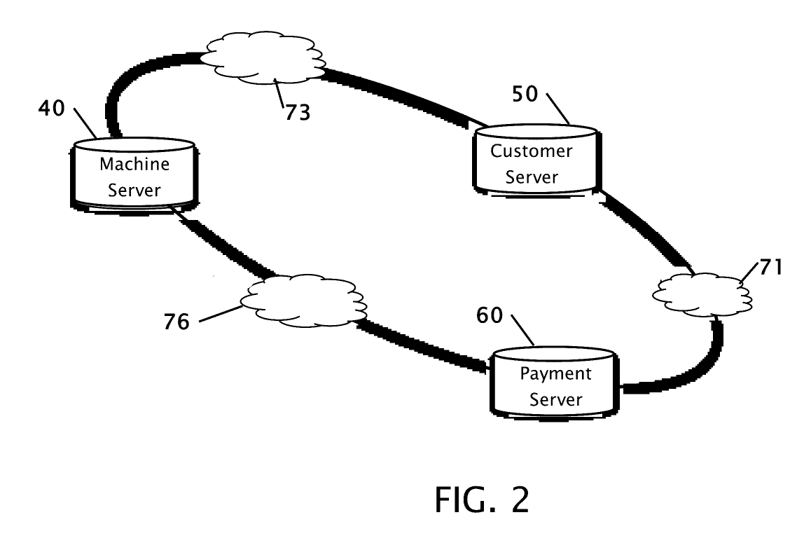

FIG. 2 shows a block diagram of the three main servers in the Uber Café Callisto product family. The system includes a machine server 40 connected through a cloud interface 73 to a payment server, through a cloud interface to a customer server 60. The smart device 20 communicated through the cloud 72 to the payment server 50 and though the cloud 70 to a customer server 60. The payment server 60 can also communicate through the cloud 76 to the machine server 40 thereby communications between the major blocks of the machine server 40, customer server 50 and the payment server 60 are each in communication. The hot and cold dispensing is with a thermoelectric module to heat and cool fluids. The dispenser can include a carbonation or CO2 gas dispenser to produce carbonated beverages.

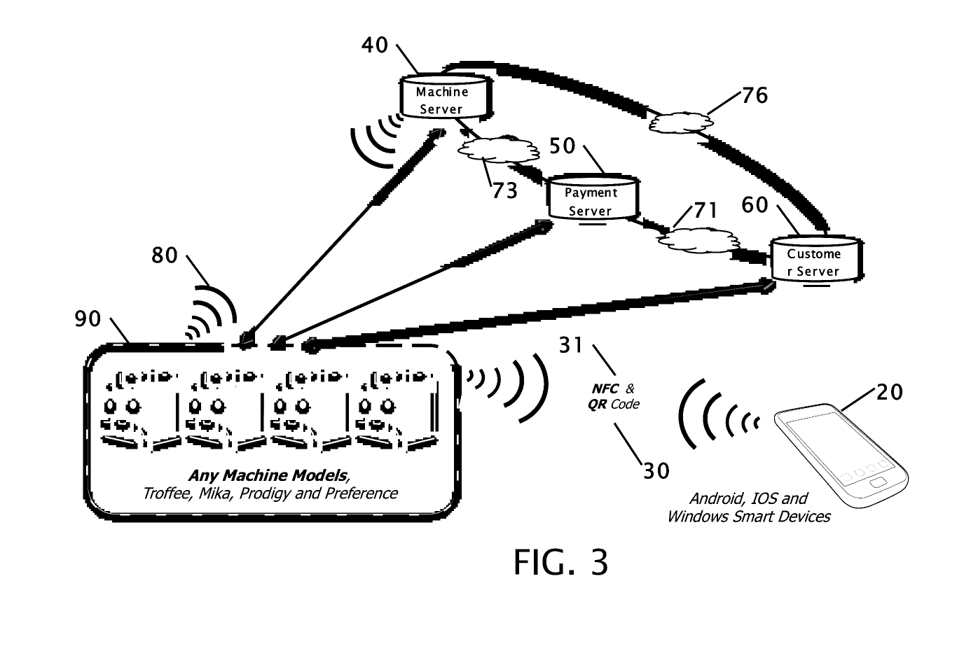

FIG. 3 shows the three main servers in the Uber Café Callisto product family. In this embodiment the computing device 20 communicates to a beverage dispenser using Near Field Communication (NFC) 31 or a Quick Response (QR) code 30. The beverage maker/dispenser can then communicate to any or all of the payment server machine server 40 and customer server 50 and the payment server 60. These three servers can communicate and/or transfer information through their cloud communication links 71, 73 and 76. The computing device 20 or cell phone can pre-order a beverage so it is ready when the owner arrives at the hot or cold beverage dispensing machine. The hot or cold beverage dispensing machine can use the proximity of the user to establish order of preparation and delivery.

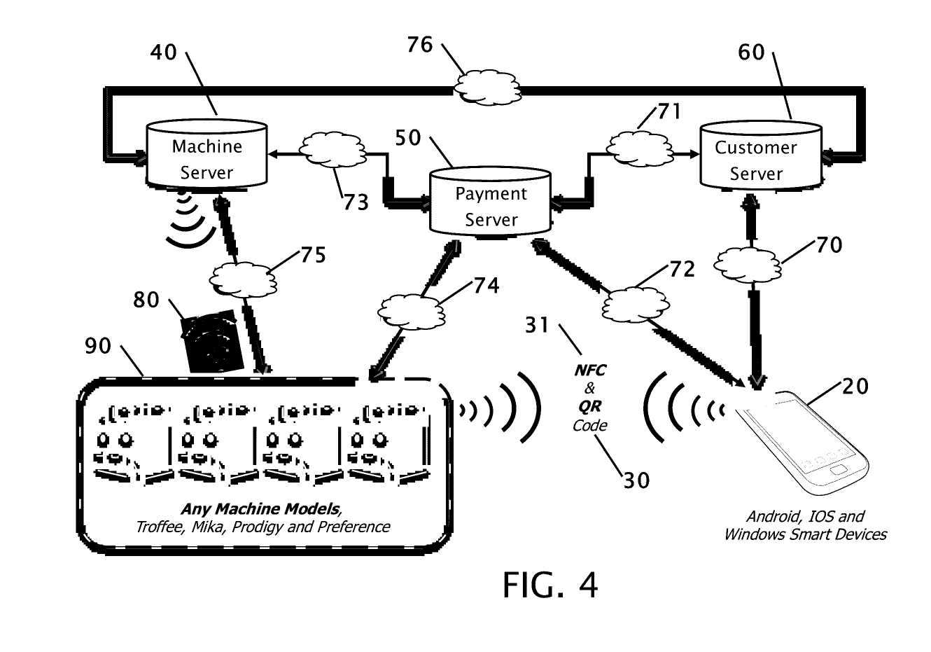

FIG. 4 shows a second block diagram of the Uber Café Callisto product family. This block diagram is a hybrid between the previously identified block diagrams with the inclusion of the cloud communication 76 between the machine server 40 and the customer server 60.

Thus, specific embodiments of a hot and cold Uber Café Callisto product family beverage dispensing machine has been disclosed. It should be apparent, however, to those skilled in the art that many more modifications besides those described are possible without departing from the inventive concepts herein. The inventive subject matter, therefore, is not to be restricted except in the spirit of the appended claims.

1. A hot or cold beverage dispensing machine comprising;
a coffee machine;
said coffee machine includes an integrated android platform, tablet PC, or android based computing system.

2. The hot or cold beverage dispensing machine according to claim 1 that further includes using an advertisement activity on a coffee machine or a hot or cold dispensing machines wherein the advertisement is pushed advertisement, live advertisement, live videos, connection to TV stations and connections to radio stations.

3. The hot or cold beverage dispensing machine according to claim 1 that further includes social media networking facilities wherein the social media networking is a group consisting of Skype, Yahoo messenger, Facebook and Twitter.

4. The hot or cold beverage dispensing machine according to claim 1 that further includes voice interactive machine or voice interactive system.

5. The hot or cold beverage dispensing machine according to claim 1 that further includes enabling QR code reading from a camera or a special QR Reader.

6. The hot or cold beverage dispensing machine according to claim 1 that further includes enabling NFC for data transfer and as payment.

7. The hot or cold beverage dispensing machine according to claim 1 that further includes reading boarding pass codes used in airlines companies for identifying the user for further processing.

8. The hot or cold beverage dispensing machine according to claim 1 that further includes using a mobile App to create, customize, modify and communicate said hot or cold dispensing machine.

9. The hot or cold beverage dispensing machine according to claim 1 that further includes integrating a RFID tag in coffee containers or liquid container, used for toppings, flavors, syrups that are used on said hot or cold dispensing machine.

10. The hot or cold beverage dispensing machine according to claim 1 that further includes integrating a RFID reader/writer in said hot or cold dispensing machine.

11. The hot or cold beverage dispensing machine according to claim 1 that further includes integrating a nozzle drip tray (NDT) system, that is a moveable container that comes beneath dispensing nozzles of the hot or cold dispensing machine.

12. The hot or cold beverage dispensing machine according to claim 1 that provides said dispensed beverage at a hot, cold or room temperate that is uniquely set by each said user.

13. The hot or cold beverage dispensing machine according to claim 1 wherein said portable computing device includes wired and/or wireless connection to an internet.

14. The hot or cold beverage dispensing machine according to claim 11 wherein said wire and/or wireless connection to the internet is selected from a group consisting of blue tooth, Wi-Fi, G3, G4 and RF and infrared.

15. The hot or cold beverage dispensing machine according to claim 1 wherein said portable computing device includes at least one user identifier selected from a group consisting of voice print, finger print, ID badge, airplane ticket, credit or ID card.

16. The hot or cold beverage dispensing machine according to claim 1 further includes an interface that stores and retrieves information and preferences from users.

17. The hot or cold beverage dispensing machine according to claim 16 further includes suggests of other combinations based up on combinations or mixtures from other users.

18. The hot or cold beverage dispensing machine according to claim 1 includes a thermoelectric device to heat or cool fluid.

19. The hot or cold beverage dispensing machine according to claim 1 further includes a carbonation or CO2 gas dispenser.

20. The hot or cold beverage dispensing machine according to claim 1 further includes communication with a user cellular device to determine when to prepare a beverage for delivery.
